(19) United States
(12) Patent Application Publication
(10) Pub. No.: US 2025/0324137 A1
(43) Pub. Date: Oct. 16, 2025

(54) METHOD FOR PROVIDING ADVERTISEMENT FOR LINEAR MEDIA SERVICE

(71) Applicant: ANYPOINT MEDIA CO., LTD., Seoul (KR)

(72) Inventors: Wonjang BAEK, Seongnam-si (KR); Doohwan LEE, Seoul (KR)

(73) Assignee: ANYPOINT MEDIA CO., LTD., Seoul (KR)

(21) Appl. No.: 19/249,565

(22) Filed: Jun. 25, 2025

Related U.S. Application Data
(63) Continuation of application No. PCT/KR2023/000900, filed on Jan. 19, 2023.

(30) Foreign Application Priority Data
Dec. 28, 2022 (KR) 10-2022-0186569

(51) Int. Cl. H04N 21/458; H04N 21/472; H04N 21/81

(52) U.S. Cl. CPC H04N 21/458; H04N 21/47217; H04N 21/812

(57) ABSTRACT

A method for providing advertisements in a linear media service includes (a) obtaining first list information about a first advertisement group to be provided during a commercial break; and (b) performing signal processing and providing at least a part of one advertisement of the first advertisement group based on the first list information during the commercial break. Step (b) includes receiving a first user input for skipping the first advertisement while providing, by signal processing, the first advertisement having a skippable attribute in the first advertisement group; in response to the first user input, stopping the first advertisement, and obtaining second list information about a second advertisement group to be provided in a first remaining time during the commercial break; and performing signal processing and providing at least a part of one advertisement of the second advertising group based on the second list information during the first remaining time.

### CROSS-REFERENCE TO RELATED PATENT APPLICATION

This non-provisional U.S. patent application is a bypass continuation application of PCT International Application No. PCT/KR2023/000900, filed on Jan. 19, 2023, in the WIPO, the international application being based upon and claiming the benefit of priority from Korean Patent Application No. 10-2022-0186569, filed on Dec. 28, 2022, in the Korean Intellectual Property Office, the entire contents of which are hereby incorporated by reference.

### BACKGROUND

### 1. Field

The present disclosure relates to a method for providing an advertisement in a linear media service, and more particularly, to a method for providing a skippable advertisement in a linear media service.

### 2. Related Art

The term “linear media service” refers to a media service that provides content to multiple users simultaneously according to a schedule.

In other words, unlike non-linear media services (e.g., video-on-demand (VOD) services), which provide content to specific users via streaming, linear media services (e.g., representative examples being linear TV services) provide content to multiple users simultaneously, for example, on a channel basis, through media such as terrestrial, satellite, or cable broadcasting. With advancements in broadcasting and communication technologies, linear media services may also be provided over the Internet.

In both linear media services and non-linear media services, content and advertisements may be provided to users.

In the non-linear media services, advertisements may be provided before, during, or after the content is provided (delivered) to the user. Examples of advertisements that may be provided in the non-linear media services include skippable advertisements and non-skippable advertisements.

A skippable advertisement is an advertisement that can be interrupted upon receiving a user input. A non-skippable advertisement is an advertisement that is provided without interruption until it ends.

For example, in a non-linear media service where advertisements are provided, at least one of a skippable advertisement or a non-skippable advertisement may be provided to the user before, during, or after the provision of content to the user. Accordingly, the user watches at least one of the skippable advertisement or the non-skippable advertisement before watching the desired content.

As described above, the non-linear media service is provided to a specific user. Accordingly, when a user input for interrupting (skipping) a skippable advertisement is received while the skippable advertisement is being provided to the user, the next advertisement (which may be a skippable advertisement or a non-skippable advertisement) or content to be served is subsequently provided to the user.

That is, since the non-linear media service does not follow a specific schedule, the next advertisement or content can be immediately provided to the user when the user input for skipping a skippable advertisement is received.

On the other hand, in the linear media service, content and advertisements are provided according to a schedule. Accordingly, it is difficult to provide skippable advertisements in the linear media service.

That is, since content is provided simultaneously to multiple users based on the schedule in the linear media service, it is difficult to alter the schedule to provide skippable advertisements to only a specific user. In other words, because advertisement times (commercial breaks) are also designated based on the schedule in the linear media service, it is difficult to modify the advertisement time for only a specific user.

Therefore, in the conventional linear media services, only non-skippable advertisements can be provided.

### RELATED ART

### Patent Document

Patent Document 1: Korean Patent Application Publication No. 10-2022-0150608

### SUMMARY

It is an object of the technique of the present disclosure to provide a method for providing advertisements in a linear media service, in which skippable advertisements and non-skippable advertisements can be combined and provided to users. Accordingly, the method can overcome the limitation that only non-skippable advertisements must be selected for advertisement time in the linear media service, and enables the provision of personalized advertisements.

According to one aspect of the technique of the present disclosure, there is provided a method for providing an advertisement in a linear media service, the method being performed by a content playback apparatus, the method including: (a) obtaining first list information about a first advertisement group to be provided during a commercial break of the linear media service; and (b) performing signal processing and providing at least a part of one advertisement of the first advertisement group based on the first list information during the commercial break. The step (b) includes: (b-1) receiving a first user input for skipping the first advertisement while providing, by signal processing, a first advertisement having a skippable attribute in the first advertisement group; (b-2) in response to the first user input, stopping the provision of the first advertisement, and obtaining second list information about a second advertisement group to be provided in a first remaining time during the commercial break; and (b-3) performing signal processing and providing at least a part of one advertisement of the second advertisement group based on the second list information during the first remaining time.

According to the technique of the present disclosure, the skippable advertisements and the non-skippable advertisements can be combined and provided to users in the linear media service. Accordingly, it is possible to overcome the limitation that only non-skippable advertisements must be selected for advertisement time in the linear media service. Further, personalized advertisements can be provided even in the linear media service.

### BRIEF DESCRIPTION OF THE DRAWINGS

FIG. 1 is a flowchart schematically illustrating a method for providing advertisements in a linear media service according to a first embodiment of the technique of the present disclosure.

FIG. 2 is a diagram schematically illustrating a configuration of a content playback apparatus for executing the method for providing advertisements in the linear media service according to the first embodiment of the technique of the present disclosure.

FIG. 3 diagram illustrating an environment in which the content playback apparatus for executing the method for providing advertisements in the linear media service according to the first embodiment of the technique of the present disclosure is placed.

FIG. 4 is a diagram exemplarily illustrating a first advertisement group and first list information in the method for providing advertisements in the linear media service according to the first embodiment of the technique of the present disclosure.

FIG. 5 is a diagram exemplarily illustrating a step of obtaining the first list information in the method for providing advertisements in the linear media service according to the first embodiment of the technique of the present disclosure.

FIG. 6 is a flowchart schematically illustrating specific steps of a process in which at least a part of one advertisement of a first advertisement group is signal-processed and provided based on the first list information during a commercial break.

FIG. 7 is a diagram exemplarily illustrating a second advertisement group and second list information in the method for providing advertisements in the linear media service according to the first embodiment of the technique of the present disclosure.

FIG. 8 is a diagram exemplarily illustrating a step of obtaining the second list information in the method for providing advertisements in the linear media service according to the first embodiment of the technique of the present disclosure.

FIG. 9 is a flowchart schematically illustrating a method for providing advertisements in a linear media service according to a second embodiment of the technique of the present disclosure.

### DETAILED DESCRIPTION

Hereinafter, embodiments of a method for providing advertisements in a linear media service according to the technique of the present disclosure will be described mainly with reference to the drawings. Meanwhile, in the drawings for describing the embodiments of the technique of the present disclosure, for the sake of convenience of description, only a part of the practical configurations may be illustrated or the practical configurations may be illustrated while a part of the practical configurations is omitted or changed. Further, relative dimensions and proportions of parts therein may be exaggerated or reduced in size.

### First Embodiment

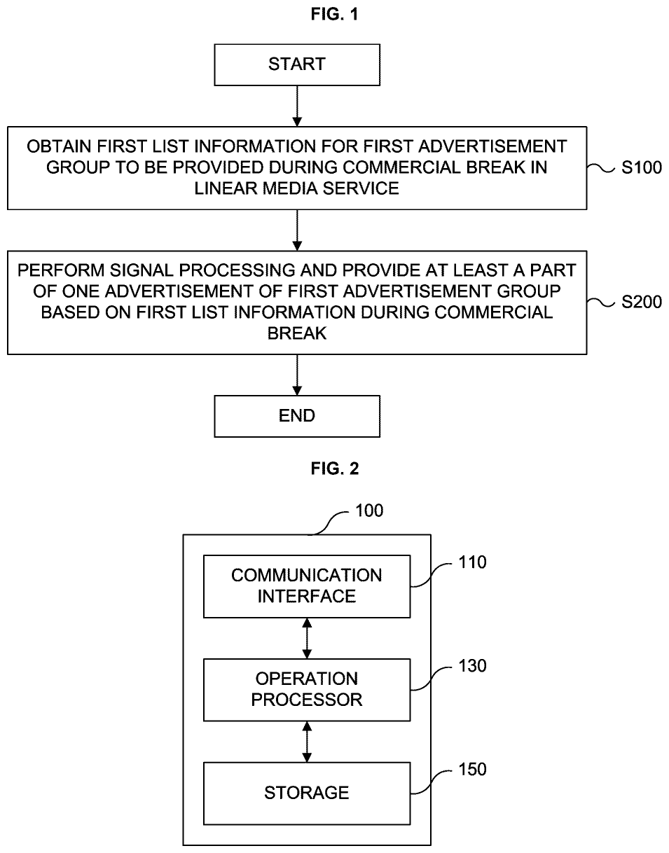

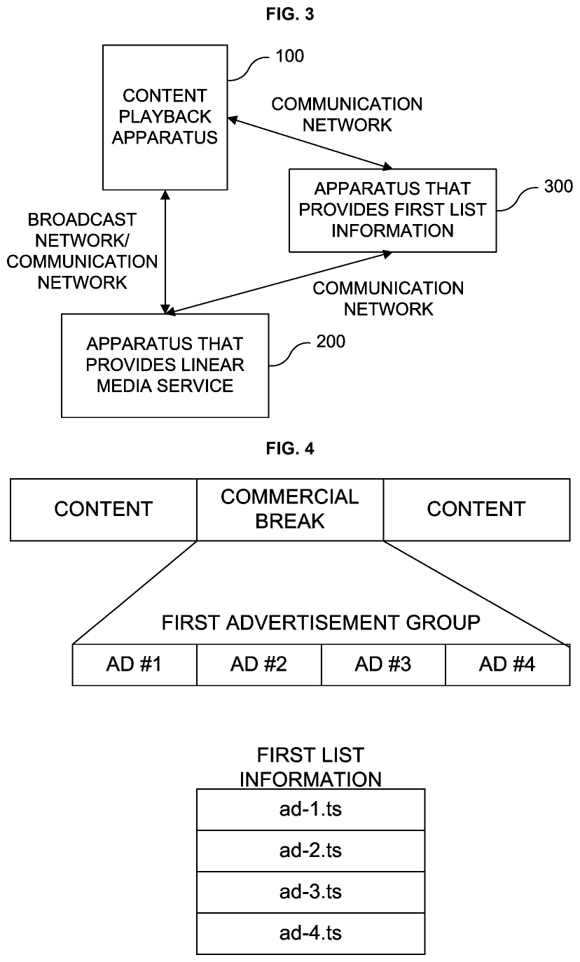

FIG. 1 is a flowchart schematically illustrating a method for providing advertisements in a linear media service according to a first embodiment of the technique of the present disclosure, FIG. 2 is a diagram schematically illustrating a configuration of a content playback apparatus for executing the method for providing advertisements in the linear media service according to the first embodiment of the technique of the present disclosure, and FIG. 3 diagram illustrating an environment in which the content playback apparatus for executing the method for providing advertisements in the linear media service according to the first embodiment of the technique of the present disclosure is placed.

First, referring to FIG. 2, a content playback apparatus 100 that executes a method for providing advertisements in a linear media service according to the first embodiment of the technique of the present disclosure will be described.

As shown in FIG. 2, the content playback apparatus 100 that executes the method for providing advertisements in the linear media service according to the first embodiment of the technique of the present disclosure may include a communication interface 110, an operation processor 130, and a storage 150.

The communication interface 110 may be a communication interface based on a wired or wireless communication method. The communication interface 110 may be implemented by a semiconductor device such as a communication chip.

The operation processor 130 may be implemented by semiconductor devices such as a central processor (CPU), a graphics processor (GPU), and an application specific integrated circuit (ASIC).

The operation processor 130 may be implemented using, for example, a plurality of semiconductor devices. For example, the operation processor 130 may be implemented using a first semiconductor device that performs a communication function and a second semiconductor device that performs signal processing and provide content and advertisements.

The operation processor 130 is configured to execute the method for providing advertisements in the linear media service according to the first embodiment, and may control the communication interface 110 and the storage 150 to execute the method for providing advertisements in the linear media service according to the first embodiment.

The storage 150 may be configured to store data. The storage unit 150 may be implemented, for example, by a semiconductor device such as a semiconductor memory. The storage 150 may store, for example, first list information, second list information, third list information, list generation reference information, filler advertisement, at least a part of one advertisement of a first advertisement group (a first group of advertisements), at least a part of one advertisement of a second advertisement group (a second group of advertisements), and at least a part of one advertisement of a third advertisement group (a third group of advertisements), which will be described later. For example, the first list information, the second list information, the third list information, at least a part of one advertisement of the first advertisement group, at least a part of one advertisement of the second advertisement group, and at least a part of one advertisement of the third advertisement group may be received from an external apparatus other than the content playback apparatus 100 and temporarily stored in the storage 150.

The storage 150 may be implemented using, for example, a plurality of semiconductor devices.

Next, referring to FIG. 3, an environment in which the content playback apparatus 100 is placed will be described.

As shown in FIG. 3, the content playback apparatus 100 may be connected to an apparatus 200 (hereinafter simply referred to as a “media server”) that provides a linear media service through at least one of a broadcast network or a communication network.

The content playback apparatus 100 may also be connected to an apparatus (hereinafter simply referred to as an “advertisement server”) 300 that provides first list information through a communication network.

The media server 200 and the advertisement server 300 may be connected through a communication network.

The content playback apparatus 100 may receive the linear media service from the media server 200. For example, the content playback apparatus 100 receives content data and performs signal processing on the content data, which is provided by the media server 200 on a channel basis, to provide its content to an end user. Although not shown, the content playback apparatus 100 may be connected to a display or may include a display.

The content playback apparatus 100 is an apparatus capable of receiving content data from the media server 200 and performing signal processing on the content data to provide its content to an end user (viewer). The content playback apparatus 100 may include, for example, an apparatus including a display, such as a television, a personal computer, a tablet computer, or a smartphone, or an apparatus such as a set-top box that is connected to a display. In other words, the content playback apparatus 100 may include not only a television or a set-top box that receives a linear media service in a broadcast format and performs signal processing on content data of the linear media service to provide its content to an end user, but also a computing apparatus capable of executing an application that receives a linear media service through a communication network and performs signal processing on content data of the linear media service to provide its content to an end user.

The media server 200 is an apparatus that provides a linear media service. That is, the media server 200 transmits content to the content playback apparatus 100 on a channel basis according to a schedule.

The media server 200 may be composed of one or more devices, and may also be referred to as a media system, for example.

The media server 200 may refer to an apparatus configured to provide any one of various linear media services including a broadcast service such as terrestrial broadcasting, cable broadcasting, or satellite broadcasting; a channel-based streaming service over a communication network; or an IPTV service. For example, if an over-the-top (OTT) service is provided on a channel basis (i.e., in the form of a linear media service), the media server 200 may refer to an apparatus configured to provide the OTT service in a channel-based manner. In addition, if a video-on-demand (VOD) service is provided in real time on a channel basis, the media server 200 may refer to an apparatus configured to provide the VOD service in real time in a channel-based manner.

The channel may include not only a physical channel (e.g., a frequency allocated for a broadcast service) but also a virtual channel. That is, the case where multiple pieces of content are provided using virtual channels through a communication network may also correspond to the linear service described herein.

The media server 200 may transmit a schedule to the content playback apparatus 100.

The schedule may include a time period during which content is provided and a time period during which an advertisement is provided.

The media server 200 may transmit one or more advertisements, which are to be signal-processed and provided by the content playback apparatus 100, to the content playback apparatus 100 during the time period in which the advertisement is provided (hereinafter also referred to as a “commercial break”).

Meanwhile, the content playback apparatus 100 may perform signal processing and provide other advertisement in place of the advertisements provided by the media server 200 during the commercial break.

The advertisement server 300 may designate one or more advertisements to be signal-processed and provided by the content playback apparatus 100 during the commercial break, and transmit the designated advertisements to the content playback apparatus 100. The advertisement server 300 may be operated by a business operator providing linear media services, but may also be operated by a separate entity.

The advertisement server 300 may transmit to the content playback apparatus 100, for example, list information regarding one or more advertisements (at least some of which may be different from one or more advertisements transmitted from the media server 200) to be signal-processed and provided by the content playback apparatus 100 during the commercial break. The content playback apparatus 100 may perform signal processing on the one or more advertisements received based on the list information and provide the one or more advertisements. For example, the content playback apparatus 100 may provide one or more advertisements by receiving the one or more advertisements and performing signal processing on the received one or more advertisements by using, for example, uniform resource identifiers (URIs) for the one or more advertisements included in the list information.

In particular, the advertisement server 300 may be used to provide personalized advertisements suitable for a user of the content playback apparatus 100. The personalized advertisements may also be referred to as targeted advertisements, customized advertisements, addressable TV advertisements, or alternative advertisements.

Hereinafter, with reference to FIG. 1, the method for providing advertisements in the linear media service according to the first embodiment of the technique of the present disclosure will be described in more detail.

Referring to FIG. 1, first, the content playback apparatus 100 (more specifically, the operation processor 130) obtains first list information for a first advertisement group to be provided during a commercial break in the linear media service (step S100).

FIG. 4 is a diagram exemplarily illustrating the first advertisement group and the first list information in the method for providing advertisements in the linear media service according to the first embodiment of the technique of the present disclosure.

Referring to FIG. 4, according to the schedule of the linear media service, a commercial break is present. During the commercial break, for example, “AD #1,” “AD t #2,” “AD #3,” and “AD #4” may be provided.

That is, for example, the first advertisement group to be provided during the commercial break of the linear media service may include “AD #1,” “AD #2,” “AD #3,” and “AD #4.”

The first list information may include information regarding one or more advertisements in the first advertisement group.

For example, the first list information may include information such as the order in which one or more advertisements in the first advertisement group are to be provided, and URIs through which the one or more advertisements in the first advertisement group can be received. At least some of the URIs may correspond to advertisements that are stored in advance in the storage 150 of the content playback apparatus 100.

Although the first list information is illustrated in a simplified manner in FIG. 4, it may actually be implemented in URI formats in accordance with standards such as the HTTP live streaming (HLS) protocol and the moving picture expert group-dynamic adaptive streaming over HTTP (MPEG-DASH) protocol. That is, although FIG. 4 shows a simplified representation for the sake of explanation, “ad-1.ts,” “ad-2.ts,” “ad-3.ts,” and “ad-4.ts” may represent URIs at each of which the corresponding advertisement in the first advertisement group is stored. Moreover, each of “ad-1.ts,” “ad-2.ts,” “ad-3.ts,” and “ad-4.ts” may include multiple pieces of information. For example, “ad-1.ts” may be composed of multiple pieces of information such as “ad-1-1.ts,” “ad-1-2.ts,” and “ad-1-3.ts.”

Although the first list information has been described based on the case where it is set and configured according to either HLS or MPEG-DASH, the present disclosure is not limited thereto. That is, the first list information may be set and configured according to a protocol different from the HLS protocol or the MPEG-DASH protocol.

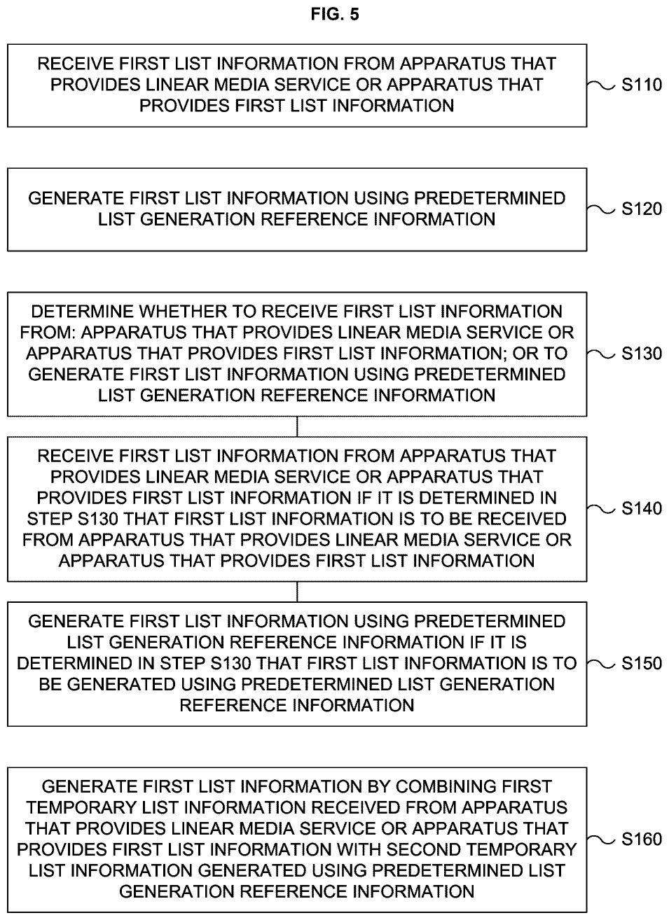

FIG. 5 is a diagram exemplarily illustrating step S100 in the method for providing advertisements in the linear media service according to the first embodiment of the technique of the present disclosure.

More specifically, FIG. 5 illustrates various examples of obtaining the first list information.

Hereinafter, the examples of obtaining the first list information will be described in more detail.

(a) Case where the First List Information is Received from the Media Server 200 or the Advertisement Server 300

Referring to FIG. 5, the operation processor 130 may receive the first list information from the media server 200 or the advertisement server 300 (step S110).

For example, the operation processor 130 may receive the first list information from the media server 200 and perform step S200, which will be described later, based on the first list information.

Meanwhile, in order to provide personalized advertisements, the operation processor 130 may receive the first list information from the advertisement server 300.

That is, the operation processor 130 may receive the first list information from the advertisement server 300 and perform step S200, which will be described later, based on the first list information.

The first list information, which is received from the advertisement server 300, may be generated by the advertisement server 300 based on, e.g., predetermined list generation reference information (predetermined reference information for list generation), such as at least one of information about the content playback apparatus 100 or information about a user of the content playback apparatus 100.

For example, the advertisement server 300 may be configured to generate first list information for a first advertisement group including personalized advertisements for a user of the content playback apparatus 100, based on at least one of the following: regional information indicating where the content playback apparatus 100 is located; specifications of the content playback apparatus 100; and user information of the content playback apparatus 100 (e.g., gender, age, presence or absence of children, purchase history, browsing history, and product preferences).

It is preferable that sensitive personal information including the user's name, address, and telephone number is not included in the user information. For example, the user information such as gender, age, presence or absence of children, purchase history, browsing history, and product preferences may be generated by analyzing the user's activity history, and does not need to be generated through direct input from the user.

The advertisement server 300 may be configured to select one or more advertisements to be included in the first advertisement group from among a plurality of advertisements based on criteria such as advertisement fees charged in connection with advertisement delivery and the list generation reference information.

As described above, the operation processor 130 may receive the first list information from the media server 200 or the advertisement server 300, and, as will be described later, may perform signal processing and provide at least a part of one advertisement of the first advertisement group during a commercial break based on the first list information obtained through step S100 (more specifically, step S110) (see step S200).

(b) Case where the Content Playback Apparatus 100 Directly Generates the First List Information

Referring to FIG. 5, the operation processor 130 may be configured to directly generate the first list information using predetermined list generation reference information (step S120).

In other words, instead of receiving the first list information from the media server 200 or the advertisement server 300, the operation processor 130 may directly generate the first list information using the predetermined list generation reference information.

For example, the operation processor 130 may be configured to select a first advertisement group including personalized advertisements for the user of the content playback apparatus 100 from among one or more advertisements stored in advance in the storage 150, using the list generation reference information.

The one or more advertisements stored in advance in the storage 150 may be personalized for the user of the content playback apparatus 100.

Thereafter, the operation processor 130 may directly generate the first list information for the first advertisement group.

As described above, the operation processor 130 may directly generate the first list information, and may perform signal processing and provide at least a part of one advertisement of the first advertisement group during a commercial break based on the first list information obtained through step S100 (more specifically, step S120), as will be described later (see step S200).

(c) Case where the Content Playback Apparatus 100 Determines the Method for Obtaining the First List Information,

Referring to FIG. 5, the operation processor 130 may be configured to determine whether to receive the first list information from the media server 200 or the advertisement server 300, or to generate the first list information using predetermined list generation reference information (step S130).

Step S130 may be performed based on a control signal transmitted from the media server 200 or the advertisement server 300. That is, for example, in a case where the media server 200 (or the advertisement server 300) transmits a control signal indicating that the first list information transmitted from the media server 200 (or the advertisement server 300) should be used for a given commercial break, the operation processor 130 determines to receive the first list information from the media server 200 (or the advertisement server 300) when the content playback apparatus 100 receives the control signal.

If it is determined in step S130 that the first list information is to be received from the media server 200 (or the advertisement server 300), the operation processor 130 receives the first list information from the media server 200 (or the advertisement server 300) (step S140). Step S140 is substantially the same as step S110, except that step S140 is performed after determining that the first list information is to be received from the media server 200 (or the advertisement server 300). Therefore, a detailed description thereof will be omitted.

If it is determined in step S130 that the first list information is to be generated using the predetermined list generation reference information, the first list information is generated using the predetermined list generation reference information (step S150). Step S150 is substantially the same as step S120, except that step S150 is performed after determining that the first list information is to be generated using the predetermined list generation reference information. Therefore, a detailed description thereof will be omitted.

(d) Case where the Content Playback Apparatus 100 Generates the First List Information by Combining Temporary Lists

Referring to FIG. 5, the operation processor 130 may be configured to generate the first list information by combining first temporary list information received from the media server 200 (or the advertisement server 300) with second temporary list information generated using predetermined list generation reference information (step S160).

For example, the first temporary list information may include information about advertisements that must be provided and information about replaceable advertisements.

Accordingly, the operation processor 130 may generate the first list information by replacing information about the replaceable advertisements in the first temporary list information with information about advertisements in the second temporary list information.

As described above, the first list information may be obtained in various ways.

Referring back to FIG. 1, during the commercial break, the operation processor 130 performs signal processing and provides at least a part of one advertisement of the first advertisement group based on the first list information obtained through step S100 (step S200).

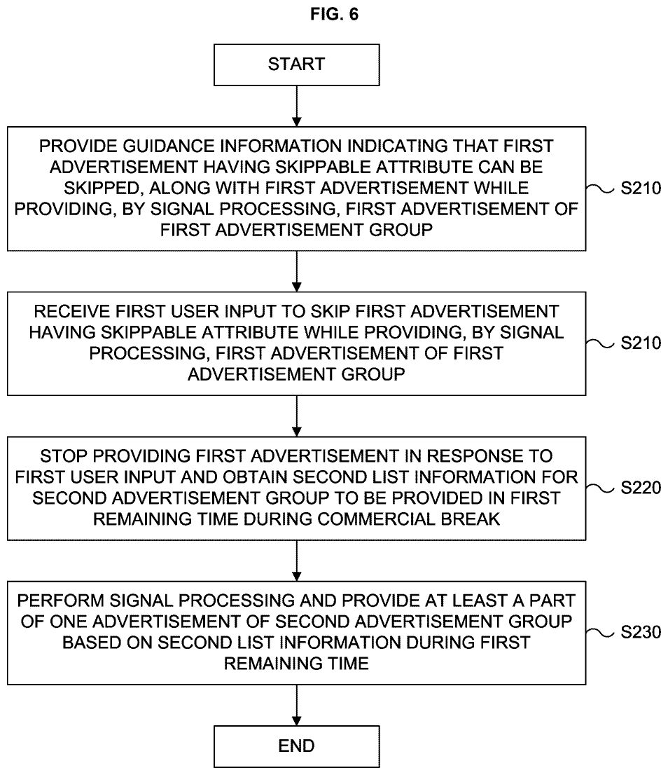

FIG. 6 is a flowchart schematically illustrating specific steps of a process in which at least a part of one advertisement of a first advertisement group is signal-processed and provided based on first list information during a commercial break.

Referring to FIG. 6, the operation processor 130 may be configured to receive a first user input to skip a first advertisement having a skippable attribute while providing, by signal processing, the first advertisement of the first advertisement group (step S210).

For example, referring to the example described with reference to FIG. 4, it is assumed that “AD #1” corresponds to a first advertisement, and “AD #4” corresponds to a second advertisement.

The first advertisement has a skippable attribute. That is, upon receiving a user input, the provision of the first advertisement is interrupted.

On the other hand, the second advertisement has a non-skippable attribute. That is, the second advertisement is provided without interruption until it ends, regardless of whether a user input is received.

Since the first advertisement has a skippable attribute, if the first advertisement is skipped during playback, it may affect the provision of other advertisements included in the first list information.

Accordingly, it is preferable that the first advertisement be provided either at the beginning portion or in the middle portion of the commercial break.

For this purpose, the first list information may be configured so that the first advertisement is provided either at the beginning portion or in the middle portion of the commercial break.

Alternatively, the first advertisement may be placed at the end portion of the commercial break. In such a case, if the first advertisement is skipped during playback, the content playback apparatus 100 may provide a filler advertisement, although the filler advertisement is not included in the first list information, as will be described later.

The second advertisement has a non-skippable attribute. Therefore, it is preferable that the second advertisement is provided at either the beginning portion or the end portion of the commercial break. For this purpose, the first list information may be configured so that the second advertisement is provided at either the beginning portion or the end portion of the commercial break.

If the second advertisement is provided at the end portion of the commercial break, there is no need to provide the filler advertisement.

Alternatively, the second advertisement may be placed in the middle portion of the commercial break.

In step S210, a first user input is received.

Meanwhile, in step S210, prior to receiving the first user input, the operation processor 130 may provide guidance information indicating that the first advertisement can be skipped, along with the first advertisement while providing, by signal processing, the first advertisement (during its playback). For example, guidance information such as “Press the red button on the remote control to skip the advertisement” may be presented to the user along with the first advertisement (e.g., overlaid on the first advertisement).

Next, in response to the first user input received in step S210, the operation processor 130 stops providing the first advertisement and obtains second list information about a second advertisement group to be provided in the remaining time during the commercial break (referred to as the first remaining time) (step S220).

When the provision of the first advertisement is stopped in step S220, the operation processor 130 does not continue to provide the remaining advertisements of the first advertisement group obtained based on the aforementioned first list information, but instead obtains second list information about a second advertisement group to be provided in the first remaining time during the commercial break.

That is, the second list information is obtained, which is configured to be suitable for the first remaining time.

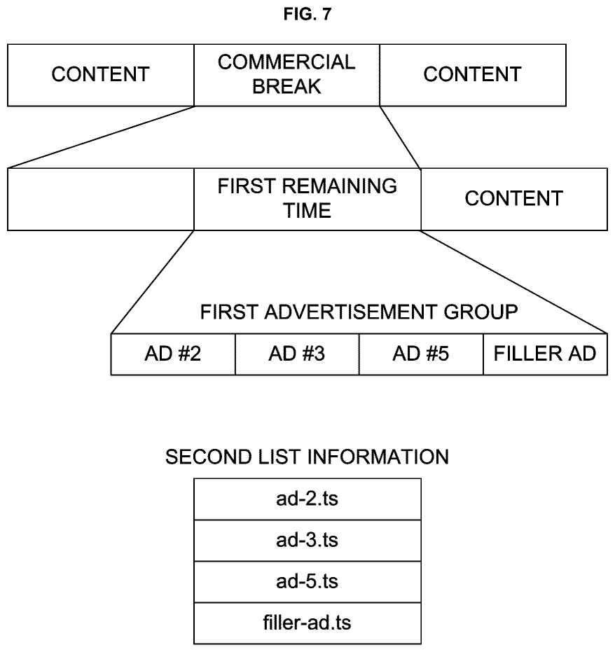

FIG. 7 is a diagram exemplarily illustrating a second advertisement group and second list information in the method for providing advertisements in the linear media service according to the first embodiment of the technique of the present disclosure.

Referring to FIG. 7, when the provision of the first advertisement is stopped during the commercial break, advertisements such as “AD #2,” “AD #3,” “AD #5,” and a “filler advertisement” may be provided in the remaining time (referred to as the first remaining time) during the commercial break, for example.

That is, for example, the second advertisement group to be provided in the first remaining time during the commercial break in the linear media service may include “AD #2,” “AD #3,” “AD #5,” and a “filler advertisement.”

The second list information includes information about one or more advertisements in the second advertisement group.

For example, the second list information may include information such as the order in which one or more advertisements in the second advertisement group are to be provided, and URIs through which the one or more advertisements in the second advertisement group can be received. At least some of the URIs may correspond to advertisements that are stored in advance in the storage 150 of the content playback apparatus 100.

Although the second list information is illustrated in a simplified manner in FIG. 7, similar to the first list information, it may actually be implemented in URI formats in accordance with standards such as the HLS protocol or the MPEG-DASH protocol. That is, although FIG. 7 shows a simplified representation for the sake of explanation, “ad-2.ts,” “ad-3.ts,” “ad-5.ts,” and “filler-ad.ts” may represent URIs at each of which the corresponding advertisement in the second advertisement group is stored. Moreover, each of “ad-2.ts,” “ad-3.ts,” “ad-5.ts,” and “filler-ad.ts” may include multiple pieces of information. For example, “ad-2.ts” may be composed of multiple pieces of information such as “ad-2-1.ts,” “ad-2-2.ts,” and “ad-2-3.ts.”

Although the second list information has been described based on the case where it is set and configured according to either HLS or MPEG-DASH, similar to the case with the first list information, the present disclosure is not limited thereto. That is, the second list information may be set and configured according to a protocol different from the HLS protocol or the MPEG-DASH protocol.

For example, referring to the example described with reference to FIG. 7, it is assumed that “AD #3” corresponds to a third advertisement, and “AD #5” corresponds to a fourth advertisement.

The third advertisement has a skippable attribute. That is, upon receiving a user input, the provision of the third advertisement is interrupted.

On the other hand, the fourth advertisement has a non-skippable attribute. That is, the fourth advertisement is provided without interruption until it ends, regardless of whether a user input is received.

Since the third advertisement has a skippable attribute, if the third advertisement is skipped during playback, it may affect the provision of other advertisements included in the second list information.

Accordingly, it is preferable that the third advertisement be provided either at the beginning portion or in the middle portion of the first remaining time.

For this purpose, the second list information may be configured so that the third advertisement is provided either at the beginning portion or in the middle portion of the first remaining time.

Alternatively, the third advertisement may be placed at the end portion of the first remaining time. In such a case, if the third advertisement is skipped during playback, the content playback apparatus 100 may provide a filler advertisement.

The fourth advertisement has a non-skippable attribute. Thus, it is preferable that the fourth advertisement is provided at either the beginning portion or the end portion of the first remaining time. For this purpose, the second list information may be configured so that the fourth advertisement is provided at either the beginning portion or the end portion of the first remaining time.

If the fourth advertisement is provided at the end portion of the first remaining time, there is no need to provide the filler advertisement. However, if a residual time remains after the provision of the fourth advertisement and the residual time is not suitable for providing another regular advertisement, the filler advertisement may be provided.

Alternatively, the fourth advertisement may be placed in the middle portion of the first remaining time.

The filler advertisement has a non-skippable attribute and, for example, a short playback time ranging from one to three seconds. Thus, the filler advertisement may be provided in cases where it is difficult to provide a regular advertisement. Preferably, the filler advertisement is stored in advance in the storage 150 of the content playback apparatus 100 and may be provided when needed.

It is preferable that the filler advertisement is placed at the end portion of the first remaining time. However, for example, the filler advertisement may be placed at the beginning portion or in the middle portion of the first remaining time. For example, when the second list information is not obtained at the beginning portion of the first remaining time, the filler advertisement may be placed at the beginning portion of the first remaining time until the second list information is obtained and advertisements can be provided normally. Additionally, when an advertisement to be provided based on the second list information cannot be obtained at the middle portion of the first remaining time, the filler advertisement may be placed at the middle portion of the first remaining time until the advertisement to be provided based on the second list information is obtained.

Meanwhile, the second advertisement group may include a fifth advertisement that is included in the first advertisement group but is not provided in step S200.

In the example described with reference to FIG. 7, it is assumed that “AD #2” corresponds to the fifth advertisement. The fifth advertisement, i.e., “AD #2,” is included in the first advertisement group illustrated in FIG. 4. If the first advertisement (i.e., “AD #1”) is skipped during playback in step S200, the operation processor 130 performs signal processing and provides at least a part of one advertisement of the second advertisement group based on the second list information during the first remaining time (see step S230 to be described below). Therefore, if the fifth advertisement is not included in the second advertisement group, the fifth advertisement cannot be provided.

However, in order to more promptly perform signal processing and provide at least a part of one advertisement of the second advertisement group based on the second list information during the first remaining time, or to include high-revenue advertisements in the second advertisement group, the second advertisement group may include the fifth advertisement.

For example, the second list information may be configured so that the fifth advertisement is provided at the beginning portion of the first remaining time. In such a case, the fifth advertisement may be obtained, signal-processed, and provided more promptly.

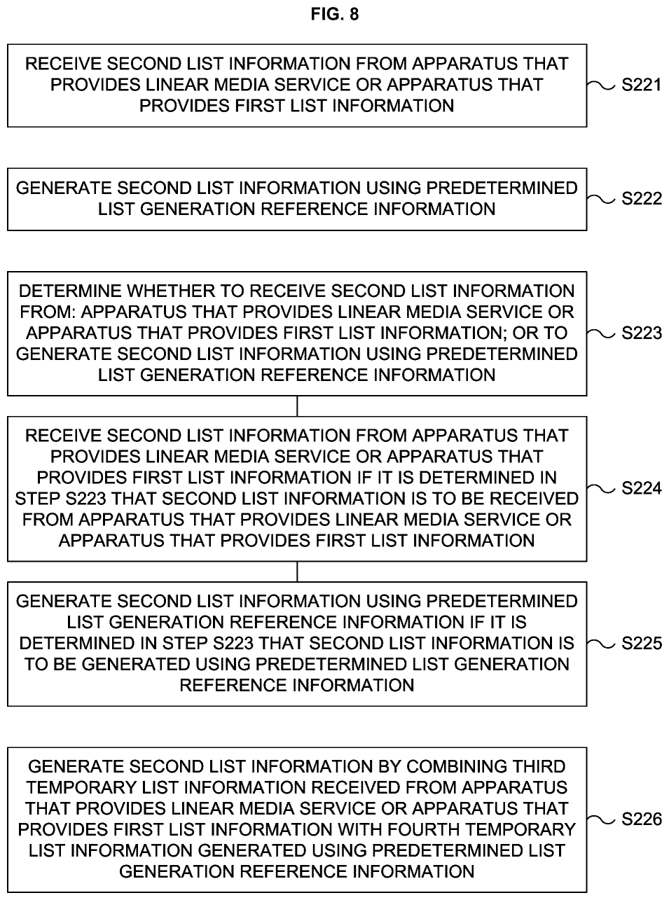

FIG. 8 is a diagram exemplarily illustrating step S220 in the method for providing advertisements in the linear media service according to the first embodiment of the technique of the present disclosure.

More specifically, FIG. 8 illustrates various examples of obtaining the second list information.

Examples of obtaining the second list information will now be described in more detail.

(a) Case where the Second List Information is Received from the Media Server 200 or the Advertisement Server 300

Referring to FIG. 8, the operation processor 130 may receive the second list information from the media server 200 or the advertisement server 300 (step S221).

That is, the operation processor 130 may receive the second list information from the media server 200 and perform step S230, which will be described later, based on the second list information.

Meanwhile, in order to provide personalized advertisements during the first remaining time, the operation processor 130 may receive the second list information from the advertisement server 300.

That is, the operation processor 130 may receive the second list information from the advertisement server 300 and perform step S230, which will be described later, based on the second list information.

The second list information, which is received from the advertisement server 300, may be generated by the advertisement server 300 based on, e.g., predetermined list generation reference information, such as at least one of information about the content playback apparatus 100 or information about a user of the content playback apparatus 100.

For example, the advertisement server 300 may be configured to generate second list information for a second advertisement group including personalized advertisements for a user of the content playback apparatus 100, based on regional information indicating where the content playback apparatus 100 is located, specifications of the content playback apparatus 100, and user information of the content playback apparatus 100 (e.g., gender, age, presence or absence of children, purchase history, browsing history, and product preferences).

As described above, it is preferable that sensitive personal information including the user's name, address, and telephone number is not included in the user information. For example, the user information such as gender, age, presence or absence of children, purchase history, browsing history, and product preferences may be generated by analyzing the user's activity history, and does not need to be obtained through direct input from the user.

The advertisement server 300 may be configured to select one or more advertisements to be included in the second advertisement group from among a plurality of advertisements based on criteria such as advertisement fees charged in connection with advertisement delivery and the list generation reference information.

Although not illustrated in FIG. 8, the operation processor 130 may transmit a request signal to the media server 200 or the advertisement server 300 in step S220, the request signal indicating a request for transmission of the second list information. In response to the request signal, the media server 200 or the advertisement server 300 may generate the second list information and transmit the generated second list information to the content playback apparatus 100.

While the foregoing example has been described on the basis that the operation processor 130 receives the second list information from the media server 200 or the advertisement server 300, preferably, the operation processor 130 may receive the second list information from the advertisement server 300.

That is, in order to minimize the processing load of the media server 200, the operation processor 130 may receive the second list information from the advertisement server 300.

In particular, in order to provide personalized advertisements suitable for the user of the content playback apparatus 100, it is preferable that the operation processor 130 receives the second list information from the advertisement server 300.

Further, the advertisement server 300 (or the media server 200) may generate the second list information by modifying the above-described first list information into a form suitable for the first remaining time, i.e., by changing the first list information to be deliverable within the first remaining time.

As described above, the operation processor 130 may receive the second list information from the media server 200 or the advertisement server 300, and, as will be described later, may perform signal processing and provide at least a part of one advertisement of the second advertisement group during the first remaining time based on the second list information obtained in step S220 (more specifically, step S221) (see step S230).

(b) Case where the Content Playback Apparatus 100 Directly Generates the Second List Information

Referring to FIG. 8, the operation processor 130 may be configured to directly generate the second list information using predetermined list generation reference information (step S222).

In other words, instead of receiving the second list information from the media server 200 or the advertisement server 300, the operation processor 130 may directly generate the second list information based on the predetermined list generation reference information.

For example, the operation processor 130 may be configured to select a second advertisement group including personalized advertisements for the user of the content playback apparatus 100 from among one or more advertisements stored in advance in the storage 150, based on the predetermined list generation reference information.

The one or more advertisements stored in advance in the storage 150 may be personalized for the user of the content playback apparatus 100.

Thereafter, the operation processor 130 may directly generate the second list information for the second advertisement group.

The operation processor 130 may, for example, generate the second list information by modifying the above-described first list information into a form suitable for the first remaining time, i.e., by changing the first list information to be deliverable within the first remaining time.

As described above, the operation processor 130 may directly generate the second list information, and, as will be described later, may perform signal processing and provide at least a part of one advertisement of the second advertisement group during the first remaining time based on the second list information obtained in step S220 (see step S230).

The method in which the operation processor 130 directly generates the second list information is particularly advantageous in that it allows for rapid generation of the second list information.

(c) Case where the Content Playback Apparatus 100 Determines the Method of Obtaining the Second List Information

Referring to FIG. 8, the operation processor 130 may be configured to determine whether to receive the second list information from the media server 200 or the advertisement server 300, or to generate the second list information using predetermined list generation reference information (step S223).

Step S223 may be performed based on a control signal transmitted from the media server 200 or the advertisement server 300. That is, for example, in a case where the advertisement server 300 (or the media server 200) transmits a control signal indicating that, for the first remaining time, the second list information transmitted from the advertisement server 300 (or the media server 200) should be used, the operation processor 130 determines to receive the second list information from the advertisement server 300 (or the media server 200) when the content playback apparatus 100 receives the control signal.

If it is determined in step S223 that the second list information is to be received from the advertisement server 300 (or the media server 200), the operation processor 130 receives the second list information from the advertisement server 300 (or the media server 200) (step S224). Step S224 is substantially the same as step S221, except that step S224 is performed after determining that the second list information is to be received from the advertisement server 300 (or the media server 200). Therefore, a detailed description thereof will be omitted.

If it is determined in step S223 that the second list information is to be generated using the predetermined list generation reference information, the second list information is generated using the predetermined list generation reference information (step S225). Step S225 is substantially the same as step S222, except that step S225 is performed after determining that the second list information is to be generated using the predetermined list generation reference information. Therefore, a detailed description thereof will be omitted.

(d) Case where the Content Playback Apparatus 100 Generates the Second List Information by Combining Temporary Lists

Referring to FIG. 8, the operation processor 130 may be configured to generate the second list information by combining third temporary list information received from the advertisement server 300 (or the media server 200) with fourth temporary list information generated using predetermined list generation reference information (step S226).

For example, the third temporary list information may include information about advertisements that must be provided and information about replaceable advertisements.

Accordingly, the operation processor 130 may generate the second list information by replacing information about the replaceable advertisements in the third temporary list information with information about advertisements in the fourth temporary list information.

As described above, the second list information may be obtained in various ways.

Next, the operation processor 130 performs signal processing and provides at least a part of one advertisement of the second advertisement group based on the second list information during the first remaining time (step S230).

As described above, according to the first embodiment, both skippable advertisements and non-skippable advertisements may be provided to the user even in the linear media service. Therefore, it is possible to eliminate the restriction that only non-skippable advertisements must be selected for the commercial break of the linear media service. In addition, personalized advertisements may also be provided in the linear media service.

### Second Embodiment

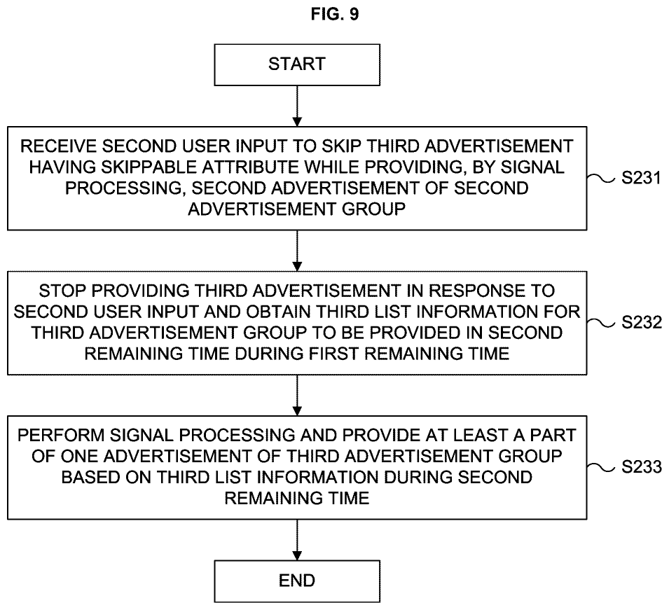

FIG. 9 is a flowchart schematically illustrating a method for providing advertisements in a linear media service according to a second embodiment of the technique of the present disclosure.

The method for providing advertisements in the linear media service according to the second embodiment of the technique of the present disclosure may be performed after performing the method for providing advertisements in the linear media service according to the first embodiment described above.

Accordingly, in the method for providing advertisements in the linear media service according to the second embodiment of the technique of the present disclosure, the above-described steps S100 and S200 are also performed.

Hereinafter, a description will be given focusing on the differences in the method for providing advertisements in the linear media service according to the second embodiment, as compared with the method according to the first embodiment.

Referring to FIG. 9, while performing step S230 shown in FIG. 6, that is, while providing, by signal processing, at least a part of one advertisement of the second advertisement group during the first remaining time based on the second list information (more specifically, while providing, by signal processing, a third advertisement having a skippable attribute in the second advertisement group), the operation processor 130 receives a second user input indicating skipping of the third advertisement (step S231).

The second user input is similar to the above-described first user input except that the second user input indicates skipping of the third advertisement. Thus, a detailed description thereof will be omitted.

Next, in response to the second user input received through step S231, the operation processor 130 stops providing the third advertisement and obtains third list information for a third advertisement group to be provided in a second remaining time during the first remaining time (step S232).

The second remaining time refers to the time remaining in the first remaining time after the provision of the third advertisement is stopped.

The third advertisement group and the third list information are similar to the second advertisement group and the second list information for the first remaining time described above, except that they relate to the second remaining time. Thus, a detailed description thereof will be omitted.

For example, the third list information may also be received from the advertisement server 300 (or the media server 200), or may be generated by the content playback apparatus 100. Further, for example, the content playback apparatus 100 may determine a method of obtaining the third list information, or may generate the third list information by combining temporary lists. Other features of the second advertisement group and the second list information may similarly be applied to the third advertisement group and the third list information.

Next, the operation processor 130 performs signal processing and provides at least a part of one advertisement of the third advertisement group based on the third list information during the second remaining time (step S233).

Step S233 is similar to the aforementioned step S230, except that at least a part of one advertisement of the third advertisement group is signal-processed and provided during the second remaining time based on the third list information. Thus, a detailed description thereof will be omitted.

The third advertisement group may include at least a sixth advertisement that is included in the second advertisement group but is not provided in step S230, and the third list information may be configured so that the sixth advertisement is provided at the beginning portion of the second remaining time.

Since the sixth advertisement is provided in a manner similar to the fifth advertisement, a detailed description thereof will be omitted.

As described above, according to the second embodiment, in addition to the technical effects of the first embodiment described above, it is possible to skip another skippable advertisement based on a user input even after a skippable advertisement has already been skipped.

### Other Embodiments

While the technique of the present disclosure is described in detail by way of the embodiments described above, the technique of the present disclosure is not limited thereto and it will be apparent to those skilled in the art that the technique of the present disclosure may be modified in various ways without departing from the scope thereof.

For example, the technique of the present disclosure may also be applied to a content playback apparatus.

The content playback apparatus according to the technique of the present disclosure may be implemented, for example, by the above-described content playback apparatus 100.

That is, according to another aspect of the technique of the present disclosure, the content playback apparatus 100 includes a communication interface 110, an operation processor 130, and a storage 150. The operation processor 130 is configured to perform: (a) obtaining first list information about a first advertisement group to be provided during a commercial break of the linear media service; and (b) signal processing and providing at least a part of one advertisement of the first advertisement group based on the first list information during the commercial break. The step (b) includes (b-1) receiving a first user input for skipping the first advertisement while providing, by signal processing, a first advertisement having a skippable attribute in the first advertisement group; (b-2) in response to the first user input, stopping the provision of the first advertisement, and obtaining second list information about a second advertisement group to be provided in a first remaining time during the commercial break; and (b-3) performing signal processing and providing at least a part of one advertisement of the second advertisement group based on the second list information during the first remaining time.

Other technical features of the method for providing advertisements in a linear media service according to the technique of the present disclosure may also be applied in a similar way to the content playback apparatus according to the technique of the present disclosure.

Accordingly, the exemplary embodiments disclosed herein are not used to limit the technical idea of the present disclosure, but to explain the present disclosure, and the scope of the technical idea of the present disclosure is not limited by those embodiments. Therefore, the scope of protection of the present disclosure should be construed as defined in the following claims, and all technical ideas that fall within the technical idea of the present disclosure are intended to be embraced by the scope of the claims of the present disclosure.

### Industrial Applicability

According to some embodiments of the technique of the present disclosure, the skippable advertisements and the non-skippable advertisements can be combined and provided to users in the linear media service. Accordingly, it is possible to overcome the limitation that only non-skippable advertisements must be selected for advertisement time in the linear media service. Further, personalized advertisements can be provided even in the linear media service.

### EXPLANATION OF REFERENCE SYMBOLS

100: content playback apparatus
110: communication interface
130: operation processor
150: storage
200: media server
300: advertisement server

What is claimed is:

1. A method for providing an advertisement in a linear media service, the method being performed by a content playback apparatus, the method comprising:
(a) obtaining first list information about a first advertisement group to be provided during a commercial break of the linear media service; and
(b) performing signal processing and providing at least a part of one advertisement of the first advertisement group based on the first list information during the commercial break,
wherein (b) comprises:
(b-1) receiving a first user input for skipping the first advertisement while providing, by signal processing, a first advertisement having a skippable attribute in the first advertisement group;
(b-2) in response to the first user input, stopping the provision of the first advertisement, and obtaining second list information about a second advertisement group to be provided in a first remaining time during the commercial break; and
(b-3) performing signal processing and providing at least a part of one advertisement of the second advertisement group based on the second list information during the first remaining time.

2. The method of claim 1, wherein (a) comprises one of:
(a-1) receiving the first list information from an apparatus that provides the linear media service or from an apparatus that provides the first list information; and
(a-2) generating the first list information using predetermined list generation reference information.

3. The method of claim 2, wherein the predetermined list generation reference information is generated based on at least one of information about the content playback apparatus or information about a user of the content playback apparatus.

4. The method of claim 1, wherein (a) comprises:
(a-3) determining whether to receive the first list information from: an apparatus that provides the linear media service or an apparatus that provides the first list information; or to generate the first list information using predetermined list generation reference information;
(a-4) if it is determined in (a-3) to receive the first list information from the apparatus that provides the linear media service or the apparatus that provides the first list information, receiving the first list information from the apparatus that provides the linear media service or the apparatus that provides the first list information; and
(a-5) if it is determined in step (a-3) to generate the first list information using the predetermined list generation reference information, generating the first list information using the predetermined list generation reference information.

5. The method of claim 1, wherein (a) comprises:
(a-6) generating the first list information by combining first temporary list information received from an apparatus that provides the linear media service or an apparatus that provides the first list information, and second temporary list information generated using predetermined list generation reference information.

6. The method of claim 1, wherein (b) comprises:
(b-4) providing guidance information indicating that the first advertisement is skippable, together with the first advertisement, while the first advertisement is being signal-processed and provided.

7. The method of claim 1, wherein the first advertisement group includes at least the first advertisement and a second advertisement having a non-skippable attribute.

8. The method of claim 7, wherein the first list information is configured so that the first advertisement is provided at one of a beginning portion and a middle portion of the commercial break.

9. The method of claim 7, wherein the first list information is configured so that the second advertisement is provided at one of a beginning portion and an end portion of the commercial break.

10. The method of claim 1, wherein the second advertisement group includes at least a third advertisement having a skippable attribute and a fourth advertisement having a non-skippable attribute.

11. The method of claim 10, wherein the second list information is configured so that the third advertisement is provided at one of a beginning portion and a middle portion of the first remaining time.

12. The method of claim 10, wherein the second list information is configured so that the fourth advertisement is provided at one of a beginning portion or an end portion of the first remaining time.

13. The method of claim 10, wherein the second advertisement group further includes a filler advertisement having a non-skippable attribute.

14. The method of claim 13, wherein the second list information is configured so that the filler advertisement is provided at one of a beginning portion, a middle portion, and an end portion of the first remaining time.

15. The method of claim 1, wherein the second advertisement group includes a fifth advertisement that is included in the first advertisement group but is not provided in (b), and
the second list information is configured so that the fifth advertisement is provided at a beginning portion of the first remaining time.

16. The method of claim 1, wherein (b-2) comprises one of:
(b-2-1) receiving the second list information from an apparatus that provides the linear media service or an apparatus that provides the first list information; and
(b-2-2) generating the second list information using predetermined list generation reference information.

17. The method of claim 1, wherein (b-2) comprises:
(b-2-3) determining whether to receive the second list information from: an apparatus that provides the linear media service or an apparatus that provides the first list information; or to generate the second list information using predetermined list generation reference information;
(b-2-4) if it is determined in (b-2-3) to receive the second list information from the apparatus that provides the linear media service or the apparatus that provides the first list information, receiving the second list information from the apparatus that provides the linear media service or the apparatus that provides the first list information; and
(b-2-5) if it is determined in (b-2-3) to generate the second list information using the predetermined list generation reference information, generating the second list information using the predetermined list generation reference information.

18. The method of claim 1, wherein (b-2) comprises:
(b-2-6) generating the second list information by combining third temporary list information received from an apparatus that provides the linear media service or an apparatus that provides the first list information, and fourth temporary list information generated using predetermined list generation reference information.

19. The method of claim 1, wherein (b-3) comprises:
(b-3-1) while providing, by signal processing, a third advertisement having a skippable attribute in the second advertisement group, receiving a second user input for skipping the third advertisement;
(b-3-2) in response to the second user input, stopping the provision of the third advertisement, and obtaining third list information about a third advertisement group to be provided in a second remaining time during the first remaining time; and
(b-3-3) performing signal processing and providing at least a part of one advertisement of the third advertisement group based on the third list information during the second remaining time.

20. The method of claim 19, wherein the third advertisement group includes at least a sixth advertisement that is included in the second advertisement group but is not provided in (b-3), and
the third list information is configured so that the sixth advertisement is provided at a beginning portion of the second remaining time.
